(19) United States
(12) Patent Application Publication
(10) Pub. No.: US 2021/0023714 A1
(43) Pub. Date: Jan. 28, 2021

(54) Illuminated Surface as Light Source for In-Hand Object Location System

(71) Applicant: ABB Schweiz AG, Baden (CH)

(72) Inventors: Biao Zhang, West Hartford, CT (US); Thomas A. Fuhlbrigge, Ellington, CT (US); Saumya Sharma, Albany, NY (US); Yixin Liu, South Windsor, CT (US)

(73) Assignee: ABB Schweiz AG, Baden (CH)

(21) Appl. No.: 16/520,549

(22) Filed: Jul. 24, 2019

(51) Int. Cl. B25J 9/16; G03B 15/02; G02B 13/06; B25J 13/08; G06T 7/70; H04N 13/254

(52) U.S. Cl. CPC B25J 9/1697; G03B 15/02; G02B 13/06; G06T 2207/30164; G06T 7/70; H04N 13/254; B25J 13/084

(57) ABSTRACT

An in-hand object location system including at least one robotic hand including a plurality of grippers and a body and at least one camera disposed on a periphery surface of the plurality of grippers. The system also includes at least one illumination surface disposed on a periphery surface of the plurality of grippers and at least one tactile sensor disposed in the at least one illumination surface. The at least one robotic hand, the plurality of grippers, the at least one camera, the at least one illumination surface and the at least one tactile sensor are electrically connected to a controller.

### BACKGROUND OF THE INVENTION

Industrial robots are well known in the art. Such robots are intended to replace human workers in a variety of assembly tasks. It has been recognized that in order for such robots to effectively replace human workers in increasingly more delicate and detailed tasks, it will be necessary to provide sensory apparatus for the robots which is functionally equivalent to the various senses with which human workers are naturally endowed, for example, sight, touch, etc.

In robotic picking applications for small part assembly, warehouse/logistics automation, food and beverage, etc., a robot gripper needs to pick an object, then insert/place it accurately into another part. There are some traditional solutions: (1.) Customized fingers on the gripper can self-align the part to a fixed location relative to the gripper. But for different shape of the part, a different type of finger has to be made and changed. (2.) After picking up the part, the robot brings the part in front of a camera and a machine vision system detects the location of the part relative the gripper. But this extra step increases the cycle time for the robot system. (3.) The part is placed on a customized fixture and the robot is programmed to pick up the part at the same location each time. But various fixtures have to be made for different parts which may not be cost effective to produce.

Of particular importance for delicate and detailed assembly tasks is the sense of touch. Touch can be important for close-up assembly work where vision may be obscured by arms or other objects, and touch can be important for providing the sensory feedback necessary for grasping delicate objects firmly without causing damage to them. Touch can also provide a useful means for discriminating between objects having different sizes, shapes or weights. Accordingly, various tactile sensors have been developed for use with industrial robots.

However, there are problems such as easy wear and tear damage with this sensor for robotic picking and assembly applications that need to be overcome. In this problem, the robotic hand is constantly picking parts and assembling parts which means that the finger/gripper surface is prone to abrasion/wear. This implies that any tactile sensing which employs fragile thin film coatings at grip points can easily wear off. Also, any elaborate light/LED source configuration limits the size of the in-hand object location system. An additional problem is that the size of the light source and sensor are too big to mount on small robotic fingers to pick up small objects. Thus, mounting an elaborate light source for in-hand perception is not feasible. The current state of the art lacks information on object handling/gripping as a part of the robotic hand.

### BRIEF SUMMARY OF THE INVENTION

The invention provides an in-hand object location system including at least one robotic hand including a plurality of grippers and a body and at least one camera disposed on a periphery surface of the plurality of grippers. The invention also provides at least one illumination surface disposed on a periphery surface of the plurality of grippers and at least one tactile sensor disposed in the at least one illumination surface. The at least one robotic hand, the plurality of grippers, the at least one camera, the at least one illumination surface and the at least one tactile sensor are electrically connected to a controller.

The invention further provides a robotic hand device including a plurality of grippers and a body and at least one camera disposed on a periphery surface of the plurality of grippers. The invention also provides at least one illumination surface disposed on a periphery surface of the plurality of grippers and at least one tactile sensor disposed in the at least one illumination surface. The at least one robotic hand, the plurality of grippers, the at least one camera, the at least one illumination surface and the at least one tactile sensor are electrically connected to a controller.

The invention also provides a method of in-hand object location including providing at least one robotic hand including a plurality of grippers and a body and providing at least one camera disposed on a periphery surface of the plurality of grippers. The method also includes providing at least one illumination surface disposed on a periphery surface of the plurality of grippers and providing at least one tactile sensor disposed in the at least one illumination surface. The method further includes actuating the plurality of grippers to grasp a workpiece via a controller and illuminating the at least one illumination surface upon grasping the workpiece by the plurality of grippers at a point of contact pressure. The method also includes viewing the position of the workpiece via the at least one camera and comparing the relative position of the workpiece to a position of the at least one robotic hand and a position of the plurality of grippers grasping the workpiece. The method further includes determining the in-hand position of the workpiece and placing the workpiece with the correct orientation in a workspace. The at least one robotic hand, the plurality of grippers, the at least one camera, the at least one illumination surface and the at least one tactile sensor are electrically connected to the controller.

### BRIEF DESCRIPTION OF THE SEVERAL VIEWS OF THE DRAWING(S)

FIG. 1 is a perspective view of a pick and place assembly device according to an embodiment.

FIG. 2A is a perspective view of a tactile sensor according to an embodiment.

FIG. 2B is a perspective view of another tactile sensor according to an embodiment.

FIG. 3A is a perspective view of a 3D sensor film according to an embodiment.

FIG. 3B is a perspective view of a 3D reconstruction of an object disposed on the 3D sensor film of FIG. 3A.

FIG. 4A is a diagrammatic view of the structure of a 3D in-hand sensor according to an embodiment.

FIG. 4B is a perspective view of the 3D in-hand sensor of FIG. 4A.

FIG. 5 is a plan view of an in-hand object location system according to an embodiment.

FIG. 6 is a perspective view of a portion of an in-hand object location system according to another embodiment.

FIG. 7 is a diagrammatic view of a tactile sensor according to an embodiment.

FIG. 8 is schematic view of a distributed control system architecture according to an embodiment.

FIG. 9 is a flowchart for a method of in-hand object location according to an embodiment.

FIG. 10 is a block diagram of a storage medium storing machine-readable instructions in according to an embodiment.

FIG. 11 is a flow diagram for a system process contained in a memory as instructions for execution by a processing device coupled with the memory according to an embodiment.

### DETAILED DESCRIPTION OF THE INVENTION

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

In one embodiment, the invention proposes a robot hand/finger surface serving as a light source in itself by using a soft electro-luminescent material or other luminescent material. The novel idea is to use pressure sensitive illumination to replace elaborate light sources. The invention also proposes a grid pattern on the finger surface to perceive deformation in the tactile surface with greater ease. This deformation in grid can be correlated with the force with which a certain object is being held. The deformation in the grid can also show in there is pinching (too much force) or inadequate force which grasping or assembling parts.

Pressure generated illumination is seen in shoes that light up when force in applied, or even capacitive touch based activation where force makes or breaks a contact thereby turning a circuit on or off. Illumination on contact may be achieved by pressure sensitive LED arrays or a form of luminescence activated upon touch/grasp.

An in-hand object location system may be used to determine the location of a part held within a robot hand. This system may additionally provide information about the geometry of the object. This system may also be used to find a different location that may provide a better grasp of the object. Such an in-hand object location system requires a light source and a detector or camera unit within the robot hand. Mounting an elaborate light source while maintaining a compact robot hand/fingers may be challenging. This invention can overcome such a challenge. The invention proposes an illuminated robot hand/finger surface serving as a light source in itself. The idea is to use a pressure-activated glow as a light source in itself. Thus, luminescent films may be coated onto robot hands/fingers in order to serve as the light source for the in-hand object location system.

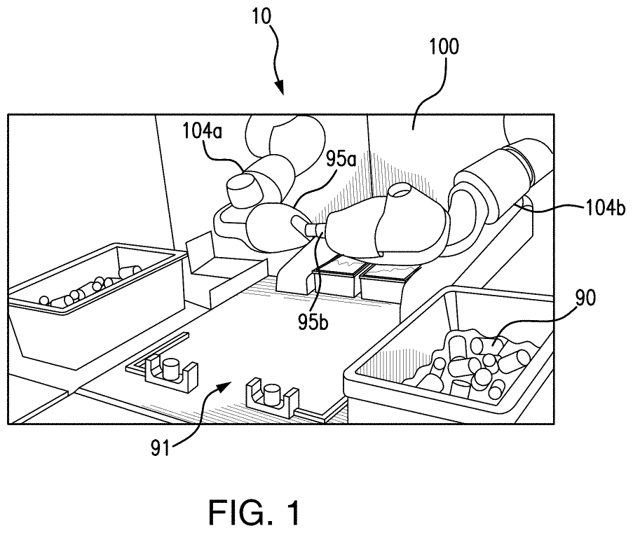

Referring now to FIG. 1, this is a robot button switch picking and assembly system 10. In many applications, a robot body portion 100 including a first robot arm 104a and a second robot arm 104b configured to provide degrees of freedom to a robot gripper/finger 95a, 95b needs to know the accurate location of a part/workpiece 90 relative to a robot gripper 95a, 95b after the robot picks up the part/workpiece 90 and moves it towards work area 91. In certain embodiments, system 10 includes an in-hand object location device, as discussed below.

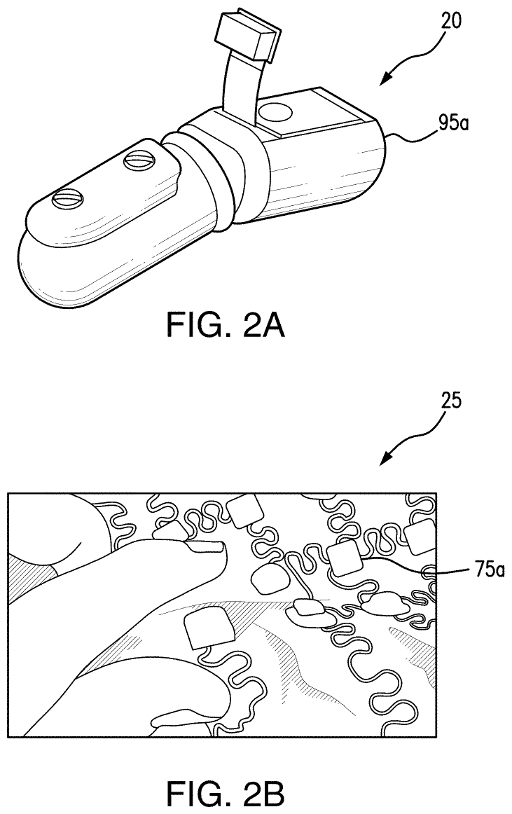

Referring now to FIGS. 2A and 2B, there are a tactile sensors 20, 25 having gripping surfaces 75a used for in-hand object location. A tactile sensor is a device that can measure contact forces between the part 90 and the gripper 95a, 95b. These sensors may be mounted or incorporated on or within a robot gripper finger 95a and may be used to detect the in-hand object location.

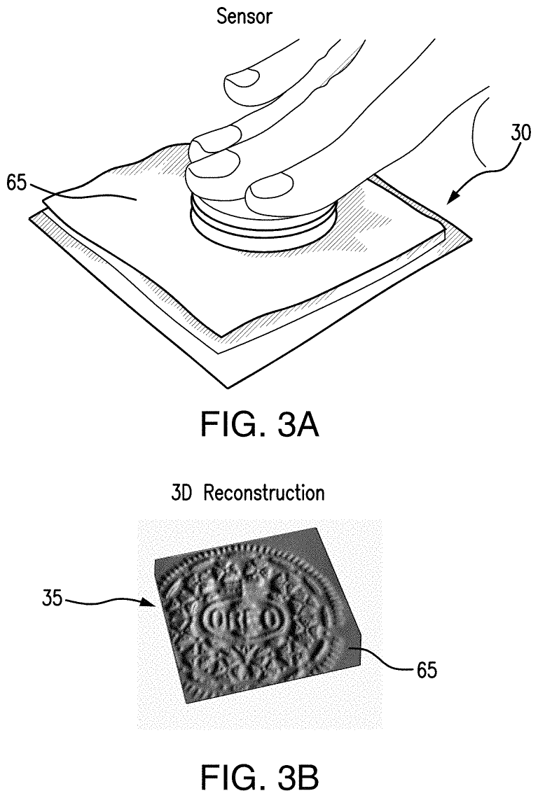

Referring now to FIGS. 3A and 3B, there is an in-hand sensor film 30, for example a GELSIGHT sensor gel film, provides high resolution (up to 2 micron) 3D reconstruction 35 of the geometry of an in-hand object as taught in U.S. Pat. Pub. 2014/0104395, entitled Methods of and System for Three-Dimensional Digital Impression and Visualization of Objects through an Elastomer, filed Oct. 17, 2013 the subject matter of which is incorporated by reference in its entirety herein. In some embodiments, film 30 may include a pressure-sensitive layer 65 configured to capture the 3D reconstruction 35 of an object it contacts to create a digital representation of the object as shown for example in FIG. 3B.

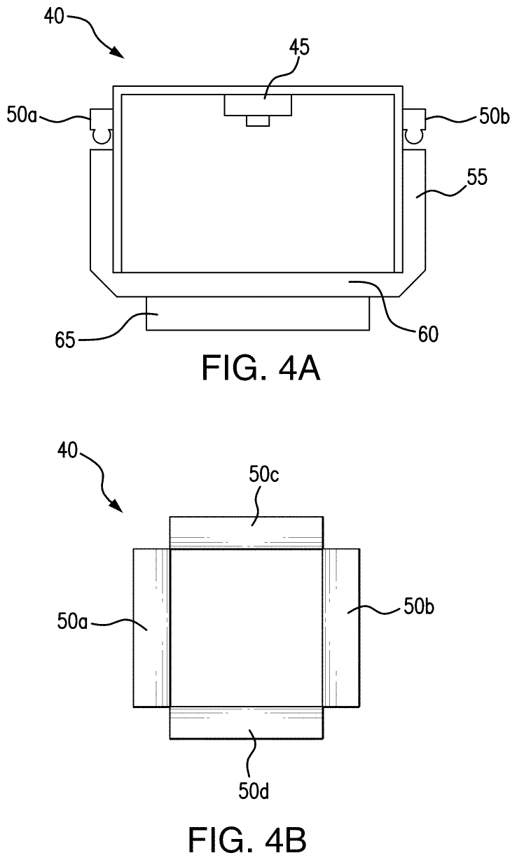

Referring now to FIGS. 4A and 4B, there is an in-hand sensor 40. Sensor 40 can be used to provide highly accurate location of in-hand object and may include a camera 45, LEDs 50a-d, light guide plate 55, a support plate 60 and elastomer gel 65 similar to sensor film 30 of FIG. 3A.

Further, the in-hand sensor 40 may include a block of transparent rubber or gel, one face of which is coated with metallic paint. When the paint-coated face is pressed against an object, it conforms to the object's shape. The metallic paint makes the object's surface reflective, so its geometry becomes much easier for computer vision algorithms to infer. Mounted on the sensor opposite the paint-coated face of the rubber block are colored lights/LEDs 50a-d and a single camera 45. This system needs to have colored lights at different angles, and then it has the reflective material, and by looking at the colors, a computer can determine a 3-D shape of what object is being sensed or touched.

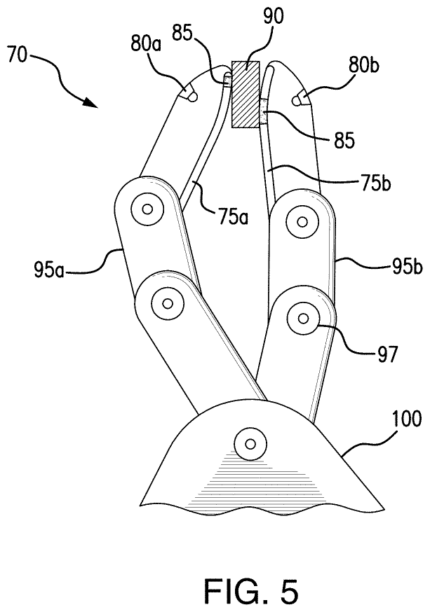

Referring now to FIG. 5, there is an in-hand object location system 70 gripping a workpiece 90 to be picked or manipulated according to an embodiment. Object location system 70 may be configured as a robotic hand including a plurality of grippers/fingers 95a, 95b configured for movement and are mechanically attached to a body portion 100, at least one in-hand camera 80a, 80b disposed on a periphery of grippers 95a, 95b. Grippers 95a, 95b may be mechanically connected via a plurality of linkages 97. Linkages 97 may include actuators or servos to initiate controlled motion thereof. Cameras 80a, 80b may comprise fish eye lenses disposed therein to capture maximum information to a vision system 145b (FIG. 8) electrically attached to the same. The fish eye lens used with in-hand object location system 70 may obtain more information than a regular lens.

Object location system 70 may also include gripping surfaces 75a, 75b disposed on a surface of grippers 95a, 95b, respectively. Gripping surfaces 75a, 75b include a layer of pressure generated illumination surfaces 85 comprised of pressure sensitive luminescent films. Using an in-hand object location system with pressure sensitive illumination can allow easy perception of the part of an object that has been gripped without the need for an elaborate light source. Illumination surfaces 85 may generate enough light to act as a light source for cameras 80a, 80b to receive better imagery of workpiece 90 as it is manipulated in-hand. In some embodiments, surfaces 85 illuminate upon coming into contact with a workpiece 90 via a pressure-activated glow effect triggered by pressure on workpiece 90. Gripping surfaces 75a, 75b, cameras 80a, 80b and grippers 95a, 95b may be electrically and mechanically connected to a power source and control system 143 (FIG. 8) as described below.

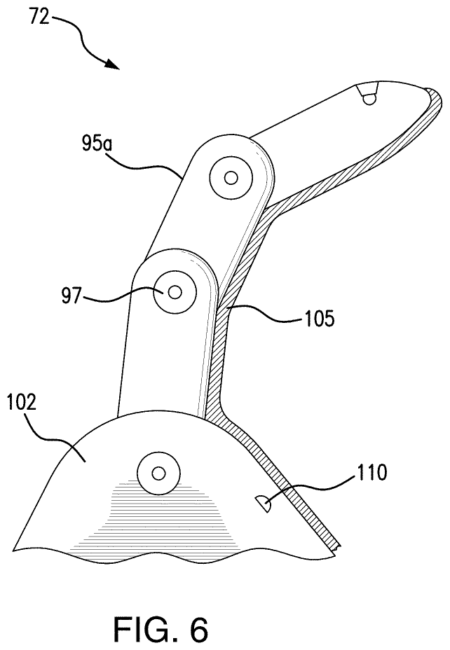

Referring now to FIG. 6, there is a portion of an in-hand object location system 72 having a glowing/illuminated film surface 105 disposed on an active portion of gripper 95a and a body portion 102. An active portion may be considered a portion directed towards workpiece 90, as shown in FIG. 5. In FIG. 6, there is an in-hand camera 110 disposed in the body portion 102 of system 72 and the illuminated film surface 105 extends onto the body portion 102 according to another embodiment. Film surface 105, gripper 95a and camera 110 may be electrically connected to a power source and a controller. Camera 110 may comprise a fish eye lens disposed therein to capture maximum information to a vision system or array 145b (FIG. 8) electrically attached to the same.

It should be appreciated that the features of film surface 105, gripper 95a and camera 110 may be duplicated in an opposing gripper (not shown) to gripper 95a in a similar configuration as that of FIG. 5 to pick and place workpiece 90 as desired by a user.

It should also be appreciated that the object location system 70, 72 may include a plurality of devices 70, 72 to provide in-hand object location of a plurality of workpiece 90, as needed by a user.

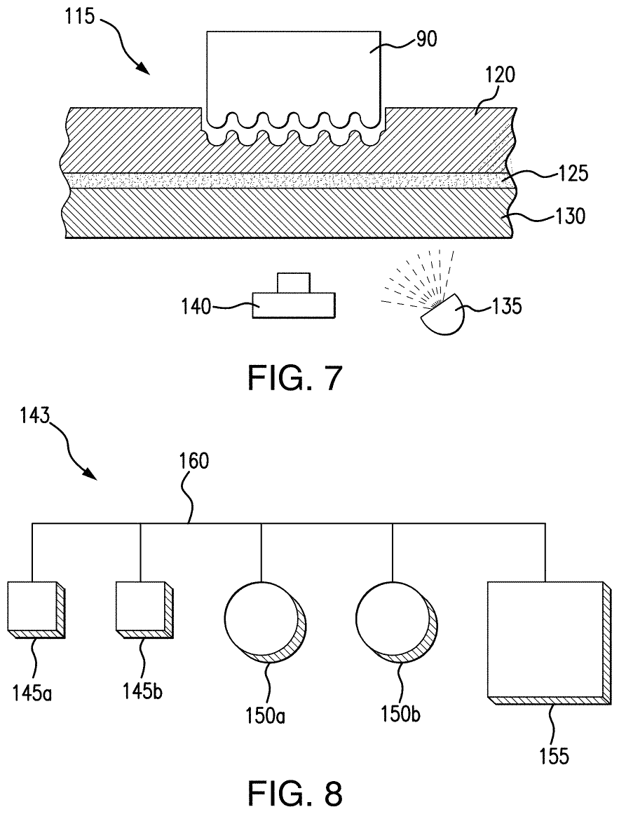

Referring now to FIG. 7, there is a tactile sensor 115 including a first elastomer 120 disposed on a first side of a reflective film 125, a second elastomer 130 disposed on a second side of the reflective film 125, a light source 135 directed towards and incident upon the second elastomer 130, and a camera 140 directed towards the second elastomer 130 to capture a 3D image of workpiece 90 in a similar manner as shown in FIGS. 3A and 3B. In some embodiments, elastomer 130 has a transparent or semi-transparent coating sandwiched adjacent the reflective film 125 as shown. First elastomer 120 is disposed and configured to be impacted by a workpiece 90 to be sensed using tactile and 3D imaging via camera 140. By sandwiching the reflective film 125 between elastomers 120 and 130 any peeling of the reflective film 125 may be prevented during repetitive use, contact or manipulation of workpiece 90 thereby making the tactile sensor 115 more durable over time. In some embodiments, tactile sensor 115 may be included within surfaces 75a, 75b or 105 described above herein to provide both a tactile and an illumination surface combination to view and manipulate workpiece 90 during use.

Referring now to FIG. 8, there is a distributed control system 143 configured to operate and control the sensors 75a, 75b and the cameras 80a, 80b as well as the robotic appendage or grippers 95a, 95b electro-mechanically connected via linkages 97 to body 100, 102 discussed above. System 143 may include components, such as, a tactile sensor array 145a, a vision array 145b, an acute actuator control module 150a, a gross actuator control module 150b and a central controller 155 all connected via a bus 160 configure to pass at least two-way signals between all components. The tactile sensor array 145a may be electrically connected to 75a, 75b or 105 in a feedback loop to control the movement of grippers 95a, 95b with respect to, for example, a pick and place operation for workpiece 90. The vision array 145b may be electrically connected to cameras 80a, 80b or 110 in a feedback loop to control the relative movement of grippers 95a, 95b with respect to, for example, a pick and place operation for workpiece 90. The acute actuator control module 150a is configured to control small and precise motion of grippers 95a, 95b and the gross actuator control module 150b is configured to control large or gross motion of gripper 95a, 95b during, for example, a pick and place operation. Central controller 155 may include a computer processor (CPU), an input/output (I/O) unit and a programmable logic controller (PLC) configured to program and operate the in-hand object location system 70, 72 described herein.

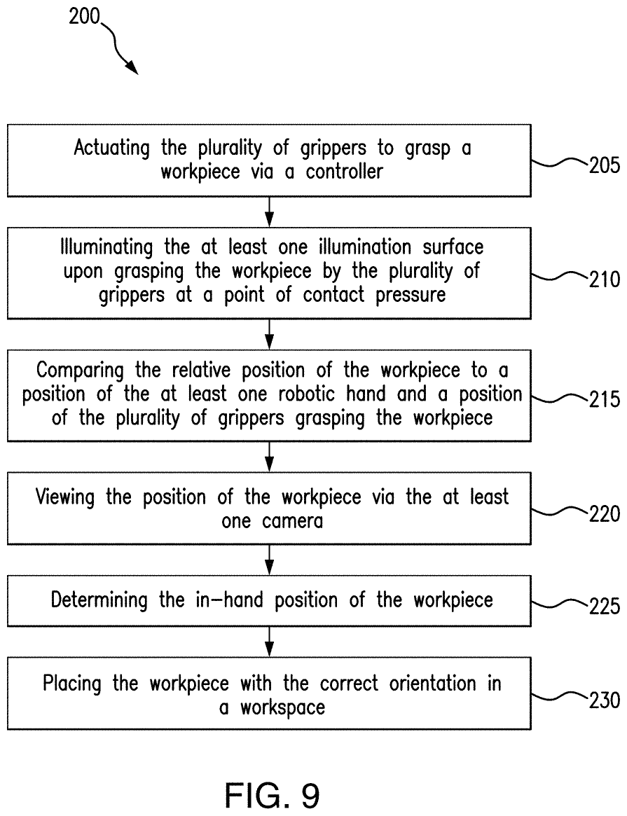

Referring now to FIG. 9, there is a method 200 of in-hand object location according to an embodiment. Method 200 includes at 205 actuating the plurality of grippers to grasp a workpiece via a controller. At, 210, the method 200 includes illuminating at least one illumination surface upon grasping the workpiece by the plurality of grippers at a point of contact pressure. At 215, the method 200 includes comparing the relative position of the workpiece to a position of the robotic hand and a position of the plurality of grippers grasping the workpiece. At 220, the method 200 includes viewing the position of the workpiece via the at least one camera. At 225, the method 200 includes determining the in-hand position of the workpiece. At 230, the method 200 includes placing the workpiece with the correct orientation in a workspace.

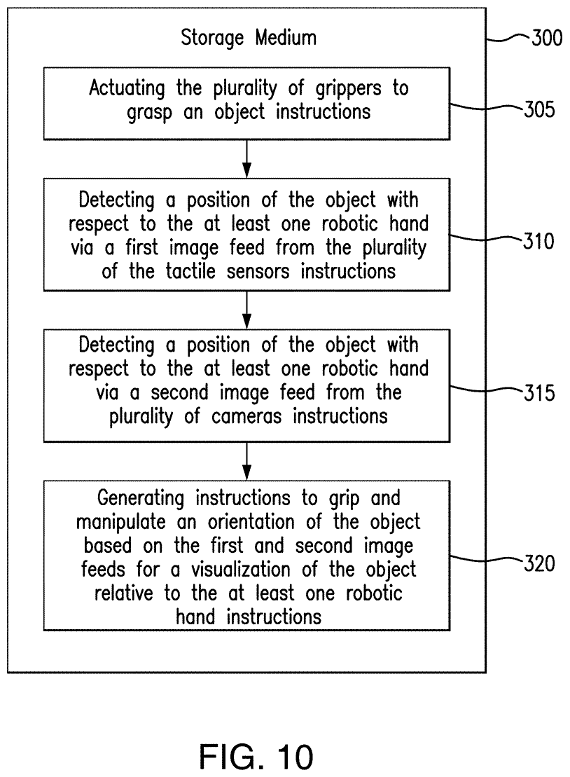

Referring now to FIG. 10, there is a block diagram for a system process contained in a memory as instructions for execution by a processing device coupled with the memory, in accordance with an exemplary embodiment of the disclosure. The instructions included on the non-transitory computer readable storage medium 300 cause, upon execution, the processing device of a vendor computer system to carry out various tasks. In the embodiment shown, the memory includes actuating instructions 305 for a plurality of grippers, using the processing device. The memory further includes detecting instructions 310 for a position of the object with respect to the at least one robotic hand via a first image feed from the plurality of tactile sensors, and detecting instructions 315 for a position of the object with respect to the at least one robotic hand via a second image feed from the plurality of cameras. The memory 300 further includes generating instructions 320 for gripping and manipulating an orientation of the object based on the first and the second image feeds for a visualization of the object relative to the at least one robotic hand.

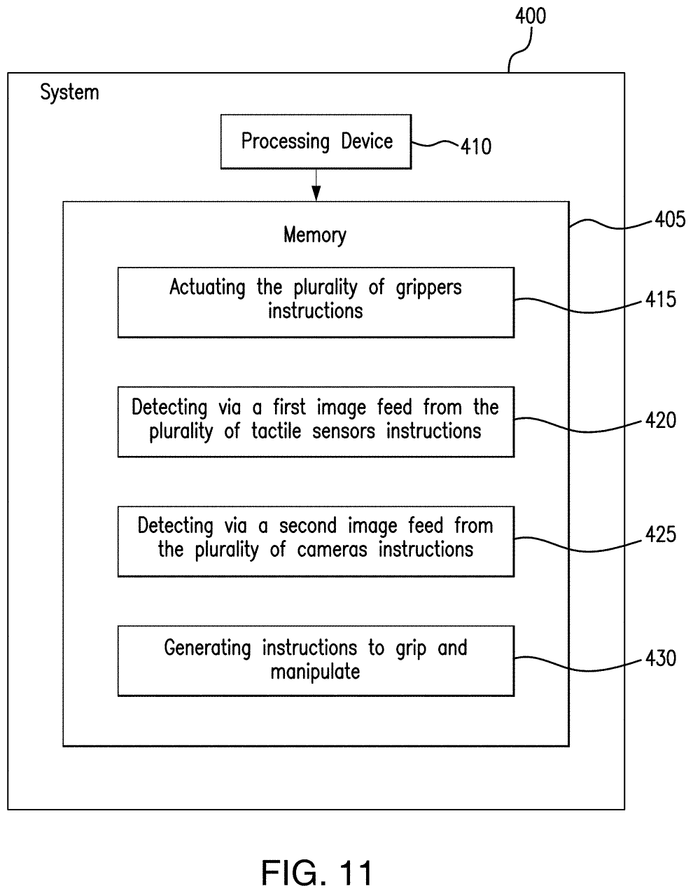

Referring now to FIG. 11, there is a flow diagram for a system process contained in a memory as instructions for execution by a processing device coupled with the memory according to an embodiment. In this embodiment, the system 400 includes a memory 405 for storing computer-executable instructions, and a processing device 410 operatively coupled with the memory 405 to execute the instructions stored in the memory. The processing device 410 is configured and operates to execute actuating instructions 415 for the plurality of grippers, and detecting instructions 420 for a first image feed from the plurality of tactile sensors. Further, processing device 410 is configured and operates to execute detecting instructions 425 for a second image feed from the plurality of cameras, and generating instructions 430 for gripping and manipulating an orientation of the object based on the first and second image feeds for a visualization of the object relative to the at least one robotic hand.

The various embodiments described herein may provide the benefits of a reduction in the engineering time and cost to design, build, install and tune a special finger, or a special fixture, or a vision system for picking, placing and assembly applications in logistics, warehouse or small part assembly. Also, these embodiments may provide a reduction in cycle time since the robotic hand can detect the position of the in-hand part right after picking the part. Further, these embodiments may provide improved robustness of the system. In other words, with the highly accurate in-hand object location and geometry, the robot can adjust the placement or assembly motion to compensate for any error in the picking. Moreover, these embodiments may be easy to integrate with general purpose robot grippers, such as the robotic YUMI hand, herein incorporated by reference, for a wide range of picking, placing and assembly applications.

The techniques and systems disclosed herein may be implemented as a computer program product for use with a computer system or computerized electronic device. Such implementations may include a series of computer instructions, or logic, fixed either on a tangible/non-transitory medium, such as a computer readable medium 300 (e.g., a diskette, CD-ROM, ROM, flash memory or other memory or fixed disk) or transmittable to a computer system or a device, via a modem or other interface device, such as a communications adapter connected to a network over a medium.

The medium 300 may be either a tangible medium (e.g., optical or analog communications lines) or a medium implemented with wireless techniques (e.g., Wi-Fi, cellular, microwave, infrared or other transmission techniques). The series of computer instructions (e.g., FIG. 11 at 415, 420, 425, 430) embodies at least part of the functionality described herein with respect to the system 400. Those skilled in the art should appreciate that such computer instructions can be written in a number of programming languages for use with many computer architectures or operating systems.

Furthermore, such instructions (e.g., at 400) may be stored in any tangible memory device 405, such as semiconductor, magnetic, optical or other memory devices, and may be transmitted using any communications technology, such as optical, infrared, microwave, or other transmission technologies.

It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware, or entirely software (e.g., a computer program product).

As will be apparent to one of ordinary skill in the art from a reading of this disclosure, the present disclosure can be embodied in forms other than those specifically disclosed above. The particular embodiments described above are, therefore, to be considered as illustrative and not restrictive. Those skilled in the art will recognize, or be able to ascertain, using no more than routine experimentation, numerous equivalents to the specific embodiments described herein. Thus, it will be appreciated that the scope of the present invention is not limited to the above described embodiments, but rather is defined by the appended claims; and that these claims will encompass modifications of and improvements to what has been described.

Preferred embodiments of this invention are described herein, including the best mode known to the inventors for carrying out the invention. Variations of those preferred embodiments may become apparent to those of ordinary skill in the art upon reading the description herein. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An in-hand object location system, comprising:
at least one robotic hand including a plurality of grippers and a body;
at least one camera disposed on a periphery surface of the plurality of grippers;
at least one illumination surface disposed on a periphery surface of the plurality of grippers; and
at least one tactile sensor disposed in the at least one illumination surface,
wherein the at least one robotic hand, the plurality of grippers, the at least one camera, the at least one illumination surface and the at least one tactile sensor are electrically connected to a controller.

2. The system of claim 1, wherein the at least one camera includes a fish eye lens.

3. The system of claim 1, wherein the at least one illumination surface is a pressure-activated luminescent surface.

4. The system of claim 1, wherein the plurality of grippers include mechanical linkages connecting the plurality of grippers to the body of the at least one robotic hand.

5. The system of claim 4, wherein the mechanical linkages include actuators configured to provide motion to the plurality of grippers via the controller.

6. The system of claim 1, wherein the at least one illumination surface is configured to provide a light source for the at least one camera.

7. The system of claim 1, wherein the controller comprises a tactile sensor array electrically connected to the at least one tactile sensor, a vision array electrically connected to the at least one camera, an acute actuator control module and a gross actuator control module connected to the robotic hand to move the plurality of grippers, and a central controller configured to connect to and to control each component via a bus.

8. The system of claim 1, wherein the at least one tactile sensor comprises a reflective film sandwiched between at least two tactile layers, a light source and a camera.

9. The system of claim 8, wherein the at least two tactile layers are elastomers.

10. The system of claim 1, wherein the camera and the light source are disposed
adjacent only one of the at least two tactile layers, and
wherein the light source and the camera are electrically connected to the controller to render a 3D image of a touched surface by the at least one tactile sensor.

11. A robotic hand device, comprising:
a plurality of grippers and a body;
at least one camera disposed on a periphery surface of the plurality of grippers;
at least one illumination surface disposed on a periphery surface of the plurality of grippers; and
at least one tactile sensor disposed in the at least one illumination surface,
wherein the at least one robotic hand, the plurality of grippers, the at least one camera, the at least one illumination surface and the at least one tactile sensor are electrically connected to a controller.

12. The robotic hand device of claim 11, wherein the at least one camera includes a fish eye lens.

13. The robotic hand device of claim 11, wherein the at least one illumination surface is a pressure-activated luminescent surface.

14. The robotic hand device of claim 11, wherein the plurality of grippers include mechanical linkages connecting the plurality of grippers to the body.

15. The robotic hand device of claim 14, wherein the mechanical linkages include actuators configured to provide motion to the plurality of grippers via the controller.

16. The robotic hand device of claim 11, wherein the at least one illumination surface is configured to provide a light source for the at least one camera.

17. The robotic hand device of claim 11, wherein the controller comprises a tactile sensor array electrically connected to the at least one tactile sensor, a vision array electrically connected to the at least one camera, an acute actuator control module and a gross actuator control module connected to the robotic hand to move the plurality of grippers, and a central controller configured to connect to and to control each component via a bus.

18. The robotic hand device of claim 11, wherein the at least one tactile sensor comprises a reflective film sandwiched between at least two tactile layers, a light source and a camera.

19. The robotic hand device of claim 18, wherein the camera and the light source are disposed adjacent only one of the at least two tactile layers, and
wherein the light source and the camera are electrically connected to the controller to render a 3D image of a touched surface by the at least one tactile sensor.

20. A method of in-hand object location, comprising:
providing at least one robotic hand including a plurality of grippers and a body;
providing at least one camera disposed on a periphery surface of the plurality of grippers;
providing at least one illumination surface disposed on a periphery surface of the plurality of grippers;
providing at least one tactile sensor disposed in the at least one illumination surface;
actuating the plurality of grippers to grasp a workpiece via a controller;
illuminating the at least one illumination surface upon grasping the workpiece by the plurality of grippers at a point of contact pressure;
viewing the position of the workpiece via the at least one camera;
comparing the relative position of the workpiece to a position of the at least one robotic hand and a position of the plurality of grippers grasping the workpiece;
determining the in-hand position of the workpiece; and
placing the workpiece with the correct orientation in a workspace,
wherein the at least one robotic hand, the plurality of grippers, the at least one camera, the at least one illumination surface and the at least one tactile sensor are electrically connected to the controller.
